(19) United States
(12) Patent Application Publication
(10) Pub. No.: US 2005/0062826 A1
(43) Pub. Date: Mar. 24, 2005

(54) Paper feeding apparatus of image forming device

(75) Inventors: Young-min Kim, Suwon-si (KR); Byung-sun Ahn, Suwon-si (KR); Sang-cheol Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/873,131

(22) Filed: Jun. 23, 2004

(30) Foreign Application Priority Data
Sep. 24, 2003 (KR) 2003-66170

(51) Int. Cl. B41J 2/01

(52) U.S. Cl. 347/104

(57) ABSTRACT

A paper feeding apparatus of an image forming device, includes: a driving source which outputs a driving force; a first roller disposed toward a first surface of a sheet of paper conveyed through a paper feeding path, and installed on a first shaft having a first roller gear to receive the driving force and thereby to rotate in a paper feeding direction to feed the sheet of paper; a second roller disposed toward a second surface of the sheet of paper to revolve in the paper feeding direction in contact with the first roller with a specified pressure, and installed on a second shaft having a second roller gear to receive the driving force and thereby to rotate in a direction opposite to the paper feeding direction; a multi sheet feed preventing part installed on the second shaft which selectively rotates the second roller in the direction opposite to the paper feeding direction to prevent a multi sheet feed; and gear trains to transmit or not transmit the driving force to the first and the second rollers.

### CROSS-REFERENCE TO RELATED APPLICATION

This application claims the priority of Korean Patent Application No. 2003-66170, filed on Sep. 24, 2003, in the Korean Intellectual Property Office, the disclosure of which is incorporated herein by reference.

### BACKGROUND OF THE INVENTION

1. Field of the Invention

The present invention relates to an image forming device such as a laser beam printer, an inkjet printer, a facsimile machine, and a multi-function machine, and more particularly, to a paper feeding apparatus of an image forming device, which conveys sheets of paper stacked in a paper cassette or a paper stacker to an engine part such as a print head or a developing unit of the image forming device.

2. Description of Prior Art

FIG. 1 shows an image forming device such as a laser beam printer to which a general paper feeding apparatus 1 is applied. The paper feeding apparatus 1 is provided with a pickup roller 2 to pick up sheets of paper P stacked in a paper cassette 3 one by one, respective first and second feed rollers 10 and 20 installed to rotate in contact with each other with a predetermined pressure to convey a sheet of paper P picked up by the pickup roller 2 through a paper feeding path, and a multi sheet feed preventing part 30 installed on the second feed roller 20 to rotate the second feed roller 20 selectively in a direction opposite to a paper feeding direction (referred as anti-paper feeding direction below) and thereby to prevent a multi sheet feed. The paper feeding apparatus 1 further comprises a first gear train 40 (shown in FIG. 3) to either transmit or not a driving force from a driving source (not shown) to the first feed roller 10, a second gear train 50 to either transmit or not the driving force from the driving source to the second feed roller 20, and respective third and fourth feed rollers 60 and 70 to convey the sheet of paper P to an engine part such as a developing unit.

As shown in FIGS. 2 and 3, the first feed roller 10 is fixed on a first feed roller shaft 11 shown in (FIG. 2) installed to rotate in the paper feeding direction. Installed at an end of the first feed roller shaft 11 is a first feed roller gear 12.

The second feed roller 20 is disposed with respect to the multi sheet preventing part 30 on a second roller shaft 21 installed to rotate in the anti-paper feeding direction. Installed at an end of the first roller shaft 21 is a second feed roller gear 22.

The multi sheet feed preventing part 30 is comprised of a torque limiter. The torque limiter is provided with a fixer 31 fixed on the second feed roller shaft 21 to rotate therewith, and a rotator 32 installed around a circumferential surface of the fixer 31 to be slidingly rotatable and having an end fixed at the second feed roller 20 to rotate therewith.

The torque limiter has a specified critical torque value, so that when a paper feeding-friction force generated between the first and second feed rollers 10 and 20 is larger than the predetermined critical torque value, the second feed roller 20 rotates in the paper feeding direction, i.e., the direction opposite to the rotary direction of the first feed roller 10, whereas when the paper feeding-friction force is less than the predetermined critical torque value, the second feed roller 20 rotates in the anti-paper feeding direction, i.e., the same direction as the rotary direction of the first feed roller 10 (referred as reverse direction below).

Accordingly, when a sheet of paper P is normally advanced into a nip between the first and the second feed roller 10 and 20, the paper feeding-friction force between the first and second feed rollers 10 and 20 comes to a frictional force between the first feed roller 10 and the sheet of paper P larger than the predetermined critical torque value of the torque limiter, so that the sheet of paper P is normally fed. However, when multi-sheets, for example two sheets of paper P are advanced into the nip between the first and the second feed roller 10 and 20, the paper feeding-friction force between the first and second feed rollers 10 and 20 comes to a frictional force between the two sheets of paper P less than the predetermined critical torque value of the torque limiter, so that the second feed roller 20 rotates in the anti-paper feeding direction, i.e., the reverse direction and thereby one of the two sheets of paper P which is in contact with the first feed roller 10 is normally fed, whereas the other of the two sheets of paper P which is in contact with the second feed roller 20 is not fed, but blocked.

The first gear train 40 is provided with a first rotating gear 42 engaged with a first driving source gear 41, a pickup roller driving gear 43 and a first feed roller driving gear 44 installed on a shaft 42a of the first rotating gear 42, a first power switching unit 45 installed on the shaft 42a of the first rotating gear 42 to either drive or not the pickup roller driving gear 43 and the first feed roller driving gear 44, first and second idle gears 46 and 47 disposed between the first feed roller driving gear 44 and the first feed roller gear 12, and a pickup roller gear 48 engaged with the pickup roller driving gear 43.

The second gear train 50 is provided with a second rotating gear 52 engaged with a second driving source gear 51, a second feed roller driving gear 53 installed on a shaft 52a of the second rotating gear 52, a second power switching unit 55 installed on the shaft 52a of the second rotating gear 52 to either drive or not the second feed roller driving gear 53, and a third idle gear 56 disposed between the second feed roller driving gear 53 and the second feed roller gear 22.

The operation of the conventional paper feeding apparatus 1 of the image forming device constructed as above is as follows.

First, with a reception of printing command, the pickup roller 2 rotates to pick up sheets of paper P stacked in the paper cassette 3 and to advance picked-up sheets of paper P into the nip between the first and second feed roller 10 and 20 positioned on the paper feeding path.

At this time, the first and second feed roller 10 and 20 are rotated by a driving force transmitted from the driving source through the first and second gear trains 40 and 50, so that the sheet of paper P is normally fed by a frictional force therebetween.

More specifically, the second feed roller shaft 21 rotates in the reverse direction (that is, the anti-paper feeding direction, or the same direction as the rotary direction of the first feed roller 10) at a speed of revolution less than that of the first feed roller 10, but the second feed roller 20 installed on the second feed roller shaft 21 rotates in the paper feeding direction by the action of the first feed roller 10 and the torque limiter of the multi sheet preventing part 30.

If multi-sheets, for example, two sheets of paper P, advance into the nip between the first and second feed roller 10 and 20, friction is generated between the two sheets of paper P, so that the second feed roller 20 rotates in the reverse direction by the action of the torque limiter, thereby the multi sheet feed is prevented as described above.

When a leading end of the sheet of paper P past between the first and the second feed roller 10 and 20 advances into a nip between the third and fourth feed rollers 60 and 70, the first and second power switching units 45 and 55 intermit a transmitting of the driving force to the first and second feed rollers 10 and 20, so that the first and second feed rollers 10 and 20 run idle.

In successive paper feeding, the operation as described above is repeated, and thereby the sheets of paper P stacked in the paper cassette 3 are fed sheet by sheet into the engine part 50 of the image forming device.

According to the conventional paper feeding apparatus 1, it is essential that since the paper feeding-friction force between the first and second feed rollers 10 and 20 acts as an import variable to prevent a sheet feeding problem such as the multi sheet feed, surfaces of the first and second feed rollers 10 and 20 have certain hardness, coefficient of friction and roughness.

At present, therefore, the first and second feed rollers 10 and 20 are formed of rubber materials such as NR series, NBR series, EPDM series, urethane series, silicon series and the like, which can not only have a superior friction characteristic, but also easily adjust the frictional force between the sheet of paper P and the first and second feed rollers 10 and 20 to obtain required frictional force, when necessary.

However, if the first and second feed rollers 10 and 20 made of the rubber materials are applied to an image forming device for high speed printing, they are apt to be worn.

Such a wear of the first and second feed roller 10 and 20 may raise a problem that particles of rubber ingredient generated by the wear are moved through the paper feeding path and attached to a certain roller such as a photoconductive drum, a transfer roller and the like in an image forming cartridge to generate image defects, or attached to a fixing roller of the fixing unit to contaminate the fixing unit and to generate an accordion jam therein.

Further, the first and second feed rollers 10 and 20 made of the rubber materials may present a problem that when the expected life span lapses, they are thermally deformed, or change a coefficient of friction and a condition in surfaces thereof at the very beginning by particles of paper being cumulatively attached thereto due to deterioration, so that they can not normally function.

Also, the first and second feed rollers 10 and 20 made of the rubber materials easily generate a static electricity when rubbed on the sheet of paper P. The static electricity may raise a problem that during image transferring, a toner image is unevenly transferred onto the sheet of paper P or a portion of the toner image is omitted and then transferred thereonto to generate image defects or alien substances such as particles of the sheet of paper P are attached onto the surfaces of the feed rollers to contaminate them.

### BRIEF SUMMARY

The invention has been developed to solve at least the above problems and/or disadvantages and to provide at least the advantages described hereinafter.

Accordingly, one aspect of the present invention is to solve the foregoing and/or other problems by providing an improved paper feeding apparatus of an image forming device, in which at least one of first and second feed rollers is formed of a roller of metal material which is not easily worn during high speed printing, and which is not thermally deformed or does not change a coefficient of friction and a condition in a surface thereof at the very beginning by particles of paper being attached thereto due to deterioration, even when used for a long time.

Another aspect of the present invention is to solve the foregoing and/or other problems by providing an improved paper feeding apparatus of an image forming device, in which at least one of first and second feed rollers is formed of a roller of metal material grounded to prevent a static electricity from being generated during paper feeding.

Still another aspect of the present invention is to solve the foregoing and/or other problems by providing an improved paper feeding apparatus of an image forming device, in which at least one of first and second feed rollers is formed of a roller of conductive metal material to which a predetermined voltage is applied to equalize a characteristic of paper such as a deviation of resistance and an uniformity of electric charge in paper.

According to an aspect of the present invention, there is provided a paper feeding apparatus of an image forming device, including: a driving source which outputs a driving force; a first roller disposed toward a first surface of a sheet of paper conveyed through a paper feeding path, and installed on a first shaft having a first roller gear to receive the driving force and thereby to rotate in a paper feeding direction to feed the sheet of paper; a second roller disposed toward a second surface of the sheet of paper to revolve in the paper feeding direction in contact with the first roller with a specified pressure, and installed on a second shaft having a second roller gear to receive the driving force and thereby to rotate in a direction opposite to the paper feeding direction; a multi sheet feed preventing part installed on the second shaft which selectively rotates the second roller in the direction opposite to the paper feeding direction to prevent a multi sheet feed; and gear trains to one of transmit and not transmit the driving force from the driving source to the first and the second rollers, wherein at least one of the first and the second rollers is formed of metal material.

The at least one of the first and the second rollers may include an outer surface finished to have a surface characteristic having a specified roughness and coefficient of friction. The finishing may be carried out by either etching or grinding the outer surface of the at least one of the first and the second rollers.

The at least one of the first and the second rollers formed of metal material may have a coating layer formed on outer surface thereof to have a specified roughness and coefficient of friction and the coating layer may be formed of a material having relatively large grains or a material resistant to heat and wear such as a ceramic or glass.

The metal material may be composed of a conductive material and the paper feeding apparatus may further include a ground to remove a static electricity generating between the sheet of paper and the at least one of the first and the second rollers during paper feeding, or a voltage applying part to apply a voltage with a specified polarity to the at least one of the first and the second rollers so as to equalize a characteristic of paper such as a deviation of resistance and electrical charge variation in the paper.

The paper feeding apparatus may include a ground installed at one of the first and the second rollers to remove a static electricity generating during paper feeding, and a voltage applying part installed at the other of the first and the second rollers to apply a voltage with a specified polarity so as to equalize a characteristic of paper such as a deviation of resistance and electrical charge variation in the paper.

When both the first and the second rollers are formed of the metal material, the first and the second rollers may be formed of the same materials for convenience of surface finishing and setting of applying voltage.

One of the first and second surfaces of the sheet of paper may be an image forming surface and the other of the first and second surfaces of the sheet of paper may be a non-image forming surface.

According to another aspect of the present invention, there is provided a paper feeding apparatus comprising: a first roller which rotates in a paper feeding direction; a second roller; and a multi-sheet feed preventer having a critical torque value and rotatably disposed on the second shaft to selectively rotate the second roller in a direction opposite the paper feeding direction when a frictional force between the sheet and the first roller is greater than the critical torque value. When a sheet and an additional sheet are advanced between the first and second rollers, a first frictional force F1 between the sheet and the first roller, a second frictional force F2 between the sheet and the additional sheet, and a third frictional force F3 between the additional sheet of paper and the second roller have magnitudes in order of F1>F3>F2, respectively, and F3 is less than the critical torque value.

According to another aspect of the present invention, there is provided a paper feeding method, including: rotating a first roller disposed toward a first surface of a sheet of paper conveyed through a paper feeding path; rotating a second roller disposed toward a second surface of the sheet of paper in the paper feeding direction; selectively rotating the second roller in the direction opposite to the paper feeding direction to prevent a multi sheet feed; and selectively transmitting a driving force to the first and the second rollers. The first roller is disposed on a first shaft having a first roller gear which receives the driving force and rotates the first roller. The second roller is disposed on a second shaft having a second roller gear which receives the driving force and rotates the second shaft in a direction opposite to the paper feeding direction. The at least one of the first and the second rollers is formed of metal material.

Additional and/or other aspects and advantages of the present invention will be set forth in part in the description which follows and, in part, will be obvious from the description, or may be learned by practice of the invention

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a schematic view of an image forming device to which a general paper feeding apparatus is applied;

FIG. 2 is a top plan view of first and second feed rollers of the paper feeding apparatus shown in FIG. 1;

FIG. 3 is a view of illustrating a driving force-transmitting relation of the paper feeding apparatus shown in FIG. 1;

FIG. 4 is a top plan view of first and second feed rollers of a paper feeding apparatus of an image forming device according to a first embodiment of the present invention;

FIG. 5 is a side elevation view of illustrating a multi sheet feed preventing operation of the first and second feed rollers of the paper feeding apparatus shown in FIG. 4;

FIG. 6 is a top plan view of a modified example of the paper feeding apparatus shown in FIG. 4;

FIG. 7 is a top plan view of first and second feed rollers of a paper feeding apparatus of an image forming device according to a second embodiment of the present invention;

FIG. 8 is a top plan view of a modified example of the paper feeding apparatus shown in FIG. 7;

FIG. 9 is a top plan view of first and second feed rollers of a paper feeding apparatus of an image forming device according to a third embodiment of the present invention;

FIG. 10 is a top plan view of first and second feed rollers of a paper feeding apparatus of an image forming device according to a fourth embodiment of the present invention;

FIG. 11 is a top plan view of first and second feed rollers of a paper feeding apparatus of an image forming device according to a fifth embodiment of the present invention;

FIG. 12 is a top plan view of first and second feed rollers of a paper feeding apparatus of an image forming device according to a sixth embodiment of the present invention; and

FIG. 13 is a schematic view of other applied example of a paper feeding apparatus of an image forming device according to the disclosed embodiments of the present invention shown.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

### Embodiment 1

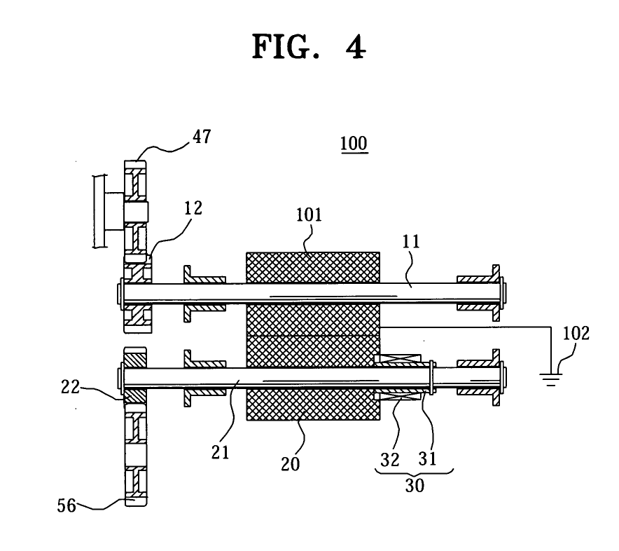

FIG. 4 schematically shows a paper feeding apparatus 100 of an image forming device according to a first embodiment of the present invention.

The paper feeding apparatus 100 according to the present invention comprises a driving source (not shown); a pickup roller 2 (not shown) to pick up sheets of paper P stacked in a paper cassette (not shown) by a driving force received from the driving source and to advance a picked-up sheet of paper P into a paper feeding path; a first feed roller 101 disposed toward a non-image forming surface of the picked-up sheet of paper P conveyed through the paper feeding path, and installed on a first feed roller shaft 11 having a first feed roller gear 12 to receive the driving force from the driving source and thereby to rotate in a paper feeding direction to feed the sheet of paper P; a second feed roller 20 disposed toward an image forming surface of the sheet of paper P conveyed through the paper feeding path to rotate in the paper feeding direction, i.e., a direction opposite to the rotary direction of the first feed roller 101, in contact with the first feed roller 101 with a predetermined pressure, and installed on a second feed roller shaft 21 having a second feed roller gear 22 to receive the driving force from the driving source and thereby to rotate in a direction opposite to the paper feeding direction, i.e., the same direction as the rotary direction of the first feed roller 101; a multi sheet feed preventing part 30 installed on the second feed roller shaft 21, and controlling to selectively rotate the second feed roller 20 in the same direction as the rotary direction of the first feed roller 101 to prevent a multi sheet feed; and first and second gear trains (not shown) to either transmit or not the driving force from the driving source to the pickup roller 2 and the first and second feed rollers 101 and 20.

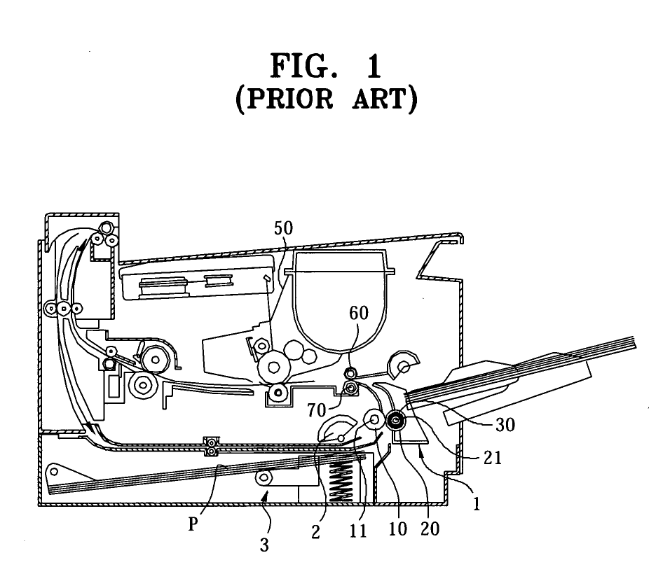

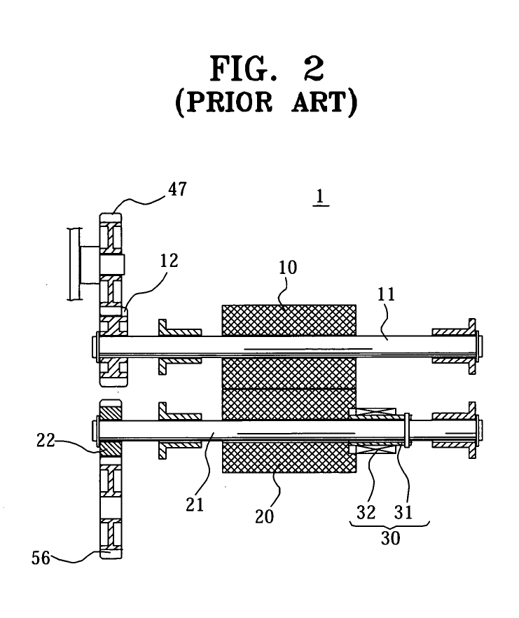

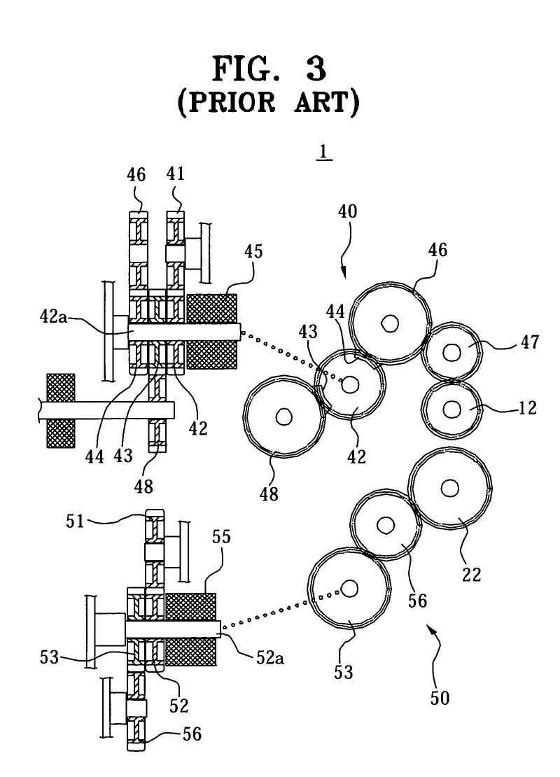

Description about the construction of the pickup roller (not shown), the second feed roller 20, the multi sheet feed preventing part 30, and the first and second gear trains (not shown) except for the first feed roller 101 will be omitted here, as they are similar to that of the ones of the conventional paper feeding apparatus 1 that are described above with reference to FIGS. 1 through 3.

The first feed roller 101 disposed toward the non-image forming surface of the sheet of paper P is formed of a cylindrical body made of conductive metal material, for example, a metal such as Cu, Al, Au, Ag, Pt, Fe, Pd, Ni, stainless steel and the like; or an alloy containing these metals as a chief ingredient.

The first feed roller 101 made of the conductive metal material has an outer surface finished to have a surface-characteristic exhibiting a desired roughness and coefficient of friction. The finishing can be carried out by etching the outer surface of the first feed roller, or grinding it by a sand blaster and the like.

Alternatively, the first feed roller 101 made of the conductive metal material can have a coating layer (not shown) formed on an outer surface thereof to exhibit a desired roughness and coefficient of friction. In this case, the coating layer is formed of material having relatively larger grains such as Mg or Ti series; or material resistant to heat and wear such as ceramic or glass series.

Like in the conventional paper feeding apparatus 1, the second feed roller 20 is formed of rubber material such as NR series, NBR series, EPDM series, urethane series, silicon series and the like, which can easily adjust a frictional force between the sheet of paper P and the second feed roller 20 to obtain a required frictional force.

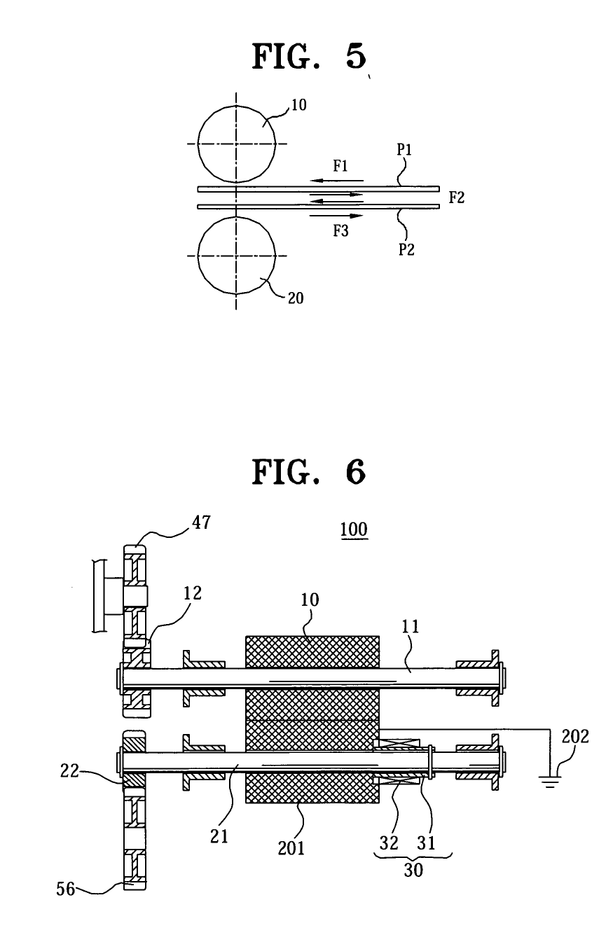

The roughness and coefficient of friction of first and second feed rollers 101 and 20 are predetermined, such that when a sheet of paper P is normally advanced into a nip between the first and second feed rollers 101 and 20, a frictional force between the sheet of paper P and the first feed roller 101 is larger than a predetermined critical torque value of a torque limiter of the multi sheet feed preventing part 30. As a result, the second feed roller 20 rotates in the paper feeding direction, i.e., the direction opposite to the rotary direction of the first feed roller 101 to convey the sheet of paper P by the action of the torque limiter of the multi sheet feed preventing part 30. And, as shown in FIG. 5, when multi sheets, for example, first and second sheet of paper P1 and P2 are abnormally advanced into the nip between the first and second feed roller 101 and 20, a first frictional force F1 between the first sheet of paper P1 and the first feed roller 101, a second frictional force F2 between the first and second sheets of paper P1 and P2, and a third frictional force F3 between the second sheet of paper P2 and the second feed roller 20 have magnitudes in order of F1>F3>F2, respectively and thereby the second sheet of paper P2 is not conveyed, but the first sheet of paper P1 is conveyed.

Since the first feed roller 101 is formed of the metal material as described above, it is not easily worn during high speed printing. Therefore, a problem that particles of rubber ingredient generated by wear are moved through the paper feeding path and attached to a, certain roller such as a photoconductive drum (not shown), a transfer roller (not shown) and the like in an image forming cartridge (not shown) to generate image defects, or attached to a fixing roller (not shown) of a fixing unit (not shown) to contaminate the fixing unit and to generate an accordion jam therein is prevented.

Further, the first feed roller 101 formed of the metal material increases life and reliability of the paper feeding apparatus 100, since even when used for a long time, it is not thermally deformed, or does not change a coefficient of friction and a condition of surface at the very beginning by particles of paper being cumulatively attached thereto due to deterioration.

The paper feeding apparatus 100 can further comprise a ground 102 for grounding the first feed roller 101 to a frame (not shown) thereof to remove a static electricity generating between the sheet of paper P and the first feed roller 101 during paper feeding.

Therefore, during the paper feeding, even when the static electricity is generated between the sheet of paper P and the first feed roller 101, it can be removed by the ground 102. Accordingly, during image transferring, the problem of uneven transfer of the toner image onto the sheet of paper P or a portion of the toner image is omitted and then transferred thereonto to generate image defects, or alien substances such as particles of the sheet of paper P are attached onto the surface of the first feed roller 101 to contaminate the first feed roller 101 is prevented.

In the paper feeding apparatus 100 of the first embodiment as described above, only the first feed roller 101 was illustrated and explained as comprised of a metal roller grounded by the ground 102, as it is disposed toward the non-image forming surface of the sheet of paper P easy to generate the static electricity and the alien substances such as the particles of the sheet of paper P. However, the second feed roller 20 also may generate the static electricity and the alien substances such as the particles of the sheet of paper P, as it is disposed toward the image forming surface of the sheet of paper P and rotates in the direction opposite to the paper feeding direction, i.e., the same direction as the rotary direction of the first feed roller 101 to prevent the multi sheet feed. Accordingly, as shown in FIG. 6, the paper feeding apparatus 100 can be deformed or modified into a paper feeding apparatus 100′ in which instead of a first feed roller 10, only a second feed roller 201 is comprised of a metal roller earthed by a ground 202.

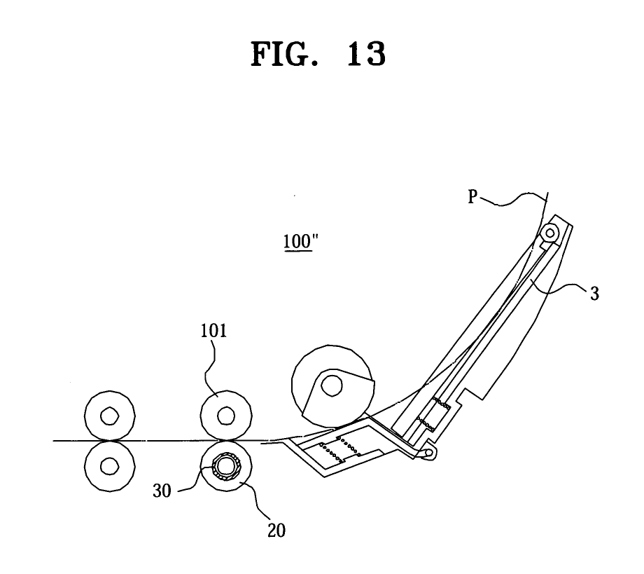

Also, in the paper feeding apparatus 100 of the first embodiment, for explanation, the first and second feed rollers 101 and 20 are illustrated and described as disposed toward the non-image forming surface and the image forming surface of the sheet of paper P, respectively, but according to paper feeding manner of the paper feeding apparatus 100, for example, as shown in FIG. 13, a top-down type paper feeding apparatus 100″ in which the sheet of paper P is fed downwardly from a paper stacker 3′ can be constructed, such that a first feed roller 101′ and a second feed roller 20′ with a multi sheet feed preventing part 30′ are disposed toward the image forming surface and the non-image forming surface of the sheet of paper P, respectively.

The description about the operation of the paper feeding apparatus 100, 100′ or 100″ of the image forming device according to the first embodiment of the present invention constructed as above will be omitted here, as it is similar to that of the conventional paper feeding apparatus 1 that is described above with reference to FIGS. 1 through 3.

### Embodiment 2

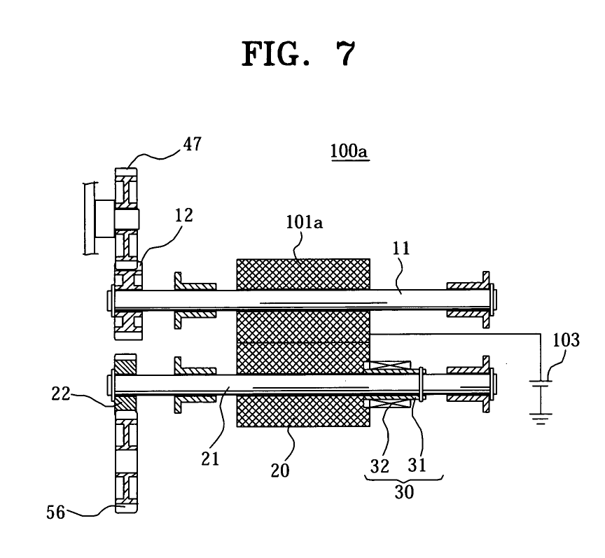

FIG. 7 schematically shows a paper feeding apparatus 100a of an image forming device according to a second embodiment of the present invention.

The paper feeding apparatus 100a of the second embodiment is identical to that of the paper feeding apparatus 100 of the first embodiment described above, except that it has a first voltage applying part 103 to apply a first voltage V1 with a predetermined polarity to a first feed roller 101a formed of the metal material, instead of having a ground to earth the first feed roller 101a.

The first voltage applying part 103 functions to equalize a characteristic of paper such as a deviation of resistance and a uniformity of electric charge in paper by applying the first voltage V1 to the first feed roller 101a formed of the metal material, thereby obtaining a transfer image of good quality during image transferring.

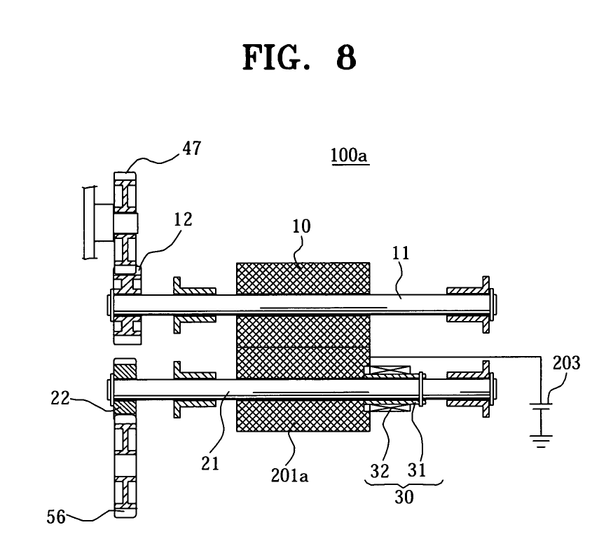

Here, it should be noted that the paper feeding apparatus 100a of the second embodiment, is illustrated and described as forming only the first feed roller 101a out of a metal roller to which the first voltage V1 is applied by the first voltage applying part 103, but as shown in FIG. 8, the paper feeding apparatus 100a is arrangeable or modified into a paper feeding apparatus 100a′ that instead of a first feed roller 10, only a second feed roller 201a is formed of a metal roller to which a second voltage V2 with a predetermined polarity is applied by a second voltage applying part 203.

Further, the paper feeding apparatus 100a of the second embodiment can be deformed into a top-down type paper feeding apparatus (not shown) such as the paper feeding apparatus 100″ shown in FIG. 13.

The description about the operation of the paper feeding apparatus 100a or 100a′ of the image forming device according to the second embodiment of the present invention constructed as above will be omitted here, as it is similar to that of the conventional paper feeding apparatus 1 that is described with reference to FIGS. 1 through 3.

### Embodiment 3

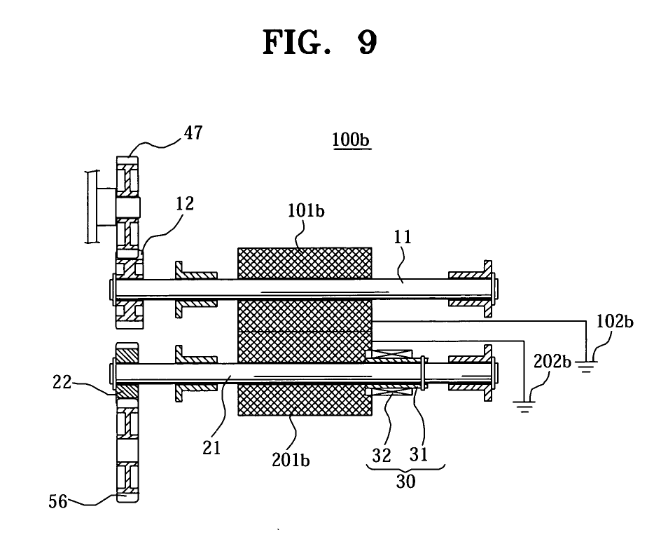

FIG. 9 schematically shows a paper feeding apparatus 100b of an image forming device according to a third embodiment of the present invention.

The paper feeding apparatus 100b of the third preferred embodiment is identical to that of the paper feeding apparatus 100 or 100′ of the first embodiment described with reference to FIGS. 4 through 6, except that both first and second feed rollers 101b and 201b are formed of metal rollers grounded by respective first and second grounds 102b and 202b, respectively.

In the paper feeding apparatus 100b of the third embodiment, it is preferable that the first and second feed rollers 101b and 201b are formed of the same metal materials to facilitate finishing of outer surfaces thereof.

Further, the paper feeding apparatus 100b of the third embodiment can be deformed into a top-down type paper feeding apparatus (not shown) such as the paper feeding apparatus 100″ shown in FIG. 13.

The description about the operation of the paper feeding apparatus 100b of the image forming device according to the third embodiment of the present invention constructed as above will be omitted here, as it is similar to that of the conventional paper feeding apparatus 1 that are described with reference to FIGS. 1 through 3.

### Embodiment 4

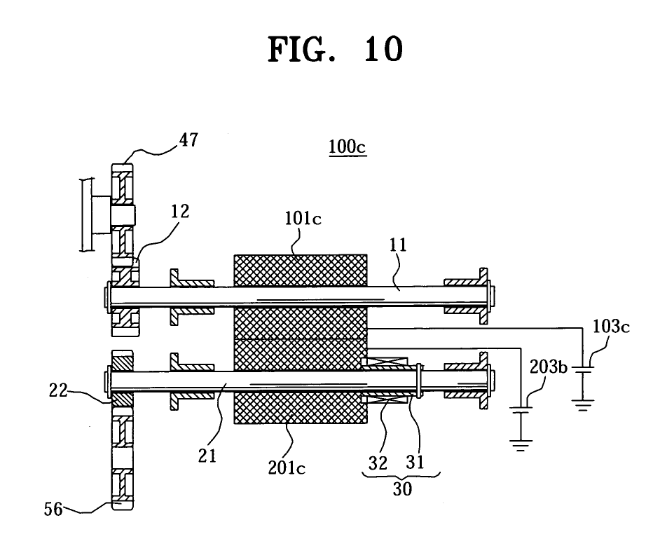

FIG. 10 schematically shows a paper feeding apparatus 100c of an image forming device according to a fourth embodiment of the present invention.

The paper feeding apparatus 100c of the fourth embodiment is identical to that of the paper feeding apparatus 100a or 100a′ of the second embodiment described with reference to FIGS. 7 and 8, except that both first and second feed rollers 101c and 201c are formed of metal rollers to which first and second voltage V1 and V2 with predetermined polarities are applied by respective first and second voltage applying parts 103c and 203b, respectively.

In the paper feeding apparatus 100c of the fourth embodiment, the first and second feed rollers 101c and 201c are formed of same metal materials to facilitate finishing of outer surfaces thereof and settling of the first and second voltage V1 and V2.

Further, the paper feeding apparatus 100c of the fourth embodiment can be employed in a top-down type paper feeding apparatus (not shown) such as the paper feeding apparatus 100″ shown in FIG. 13.

The description about the operation of the paper feeding apparatus 100c of the image forming device according to the fourth embodiment of the present invention constructed as above will be omitted here, as it is similar to that of the conventional paper feeding apparatus 1 that is described with reference to FIGS. 1 through 3.

### Embodiment 5

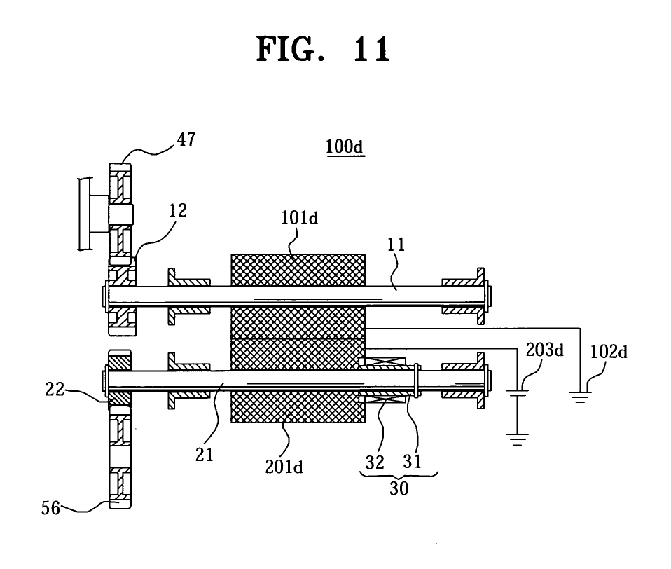

FIG. 11 schematically shows a paper feeding apparatus 100d of an image forming device according to a fifth embodiment of the present invention.

The paper feeding apparatus 100d of the fifth embodiment is identical to that of the paper feeding apparatus 100b or 100c of the third or the fourth embodiment described with reference to FIG. 9 or 10, except that a first feed roller 101d is formed of a metal roller earthed by a ground 102d and a second feed rollers 201d is formed of a metal roller to which a second voltage V2 with a predetermined polarity is applied by a voltage applying part 203d.

In the paper feeding apparatus 100d of the fifth embodiment, the ground 102d functions to remove a static electricity generating between a sheet of paper P and the first feed roller 101d during paper feeding, whereas the voltage applying part 203d functions to equalize a characteristic of paper such as a deviation of resistance and a uniformity of electric charge in paper.

The first and second feed rollers 101d and 201d are formed of same metal materials to facilitate finishing of outer surfaces thereof.

Further, the paper feeding apparatus 100d of the fifth embodiment can be employed in a top-down type paper feeding apparatus (not shown) such as the paper feeding apparatus 100″ shown in FIG. 13.

The description about the operation of the paper feeding apparatus 100d of the image forming device according to the fifth embodiment of the present invention constructed as above will be omitted here, at it is similar to that of the conventional paper feeding apparatus 1 that are described with reference to FIGS. 1 through 3.

### Embodiment 6

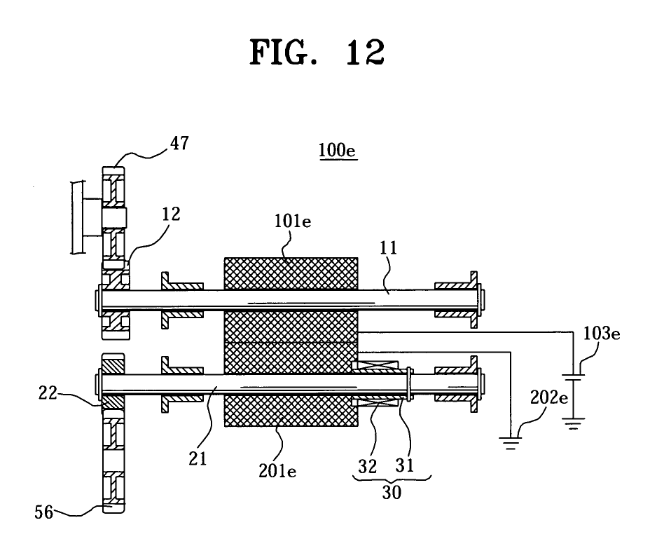

FIG. 12 schematically shows a paper feeding apparatus 100e of an image forming device according to a sixth embodiment of the present invention.

The paper feeding apparatus 100e of the sixth embodiment is identical to that of the paper feeding apparatus 100d of the fifth embodiment described with reference to FIG. 11, except that a first feed roller 101e is formed of a metal roller to which a first predetermined voltage V1 with a predetermined polarity are applied by a voltage applying part 103e and a second feed roller 201e is formed of a metal roller earthed by a ground 202e.

Further, the paper feeding apparatus 100e of the sixth embodiment can be deformed into a top-down type paper feeding apparatus (not shown) such as the paper feeding apparatus 100″ shown in FIG. 13.

The description about the operation of the paper feeding apparatus 100e of the image forming device according to the sixth embodiment of the present invention constructed as above will be omitted here, as it is similar to that of the conventional paper feeding apparatus 1 that are described with reference to FIGS. 1 through 3.

As is apparent from the foregoing description, it can be appreciated that by forming at least one of the first and second feed rollers out of metal material which is not easily worn during the high speed printing, the paper feeding apparatus of the image forming device according to the disclosed embodiments of the present invention prevents the problem that the particles of rubber ingredient generated by wear are moved through the paper feeding path and attached to the certain roller such as the photoconductive drum, the transfer roller and the like in an image forming cartridge to generate the image defects, or attached to the fixing roller of the fixing unit to contaminate the fixing unit and to generate the accordion jam therein.

Further, the paper feeding apparatus of the image forming device according to the disclosed embodiments of the present invention provides increased life and reliability, since the first and/or second feed roller is formed of the metal material, so that even when used for a long time, it is not thermally deformed, or does not change the coefficient of friction and the condition of surface at the very beginning by the particles of paper being cumulatively attached thereto due to deterioration.

Still further, with a ground of at least one of the first and second feed rollers made of the metal material, the paper feeding apparatus of the image forming device according to the disclosed embodiments present invention can prevent the problem that the toner image is unevenly transferred onto the sheet of paper or a portion of the toner image is omitted and then transferred thereonto to generate the image defects during the image transferring, or the alien substances such as the particles of the sheet of paper are attached onto the surface of the first and/or feed roller to contaminate it.

Also, with an applying of predetermined voltage to at least one of the first and second feed rollers made of the metal material, the paper feeding apparatus of the image forming device according to the present invention can equalize the characteristic of paper such as the deviation of resistance and the uniformity of electric charge in paper, thereby obtaining a transfer image of good quality during the image transferring.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

1. A paper feeding apparatus of an image forming device, comprising:
a driving source which outputs a driving force;
a first roller disposed toward a first surface of a sheet of paper conveyed through a paper feeding path, and installed on a first shaft having a first roller gear to receive the driving force and thereby to rotate in a paper feeding direction to feed the sheet of paper;
a second roller disposed toward a second surface of the sheet of paper to revolve in the paper feeding direction in contact with the first roller with a specified pressure, and installed on a second shaft having a second roller gear to receive the driving force and thereby to rotate in a direction opposite to the paper feeding direction;
a multi sheet feed preventing part installed on the second shaft which selectively rotates the second roller in the direction opposite to the paper feeding direction to prevent a multi sheet feed; and
gear trains to one of transmit and not transmit the driving force from the driving source to the first and the second rollers,
wherein at least one of the first and the second rollers is formed of metal material.

2. The apparatus of claim 1, wherein the at least one of the first and the second rollers has an outer surface finished to have a surface characteristic having specified roughness and coefficient of friction.

3. The apparatus of claim 2, wherein the finishing is carried out by one of etching and grinding the outer surface of the at least one of the first and the second rollers.

4. The apparatus of claim 1, wherein the at least one of the first and the second rollers has a coating layer formed on an outer surface thereof to have specified roughness and coefficient of friction.

5. The apparatus of claim 4, wherein the coating layer is formed of one of material having grains, and material resistant to heat and wear.

6. The apparatus of claim 4, wherein the material having grains is one of an Mg and Ti series.

7. The apparatus of claim 4, wherein the material resistant to heat and wear is one of a ceramic and glass series.

8. The apparatus of claim 1, wherein the metal is electrically conductive.

9. The apparatus of claim 8, further comprising a ground which removes a static electricity generated between the sheet of paper and the at least one of the first and the second rollers during paper feeding.

10. The apparatus of claim 8, further comprising a voltage applying part which applies a voltage with a specified polarity to the at least one of the first and the second rollers so as to equalize a characteristic of the sheet of paper such as a deviation of resistance and a variation of electric charge.

11. The apparatus of claim 8, further comprising:
a ground to remove a static electricity generating between the sheet of paper and one of the first and the second rollers during paper feeding; and
a voltage applying part which applies a voltage with a predetermined polarity to the other of the first and the second rollers so as to equalize a characteristic of the sheet of paper such as a deviation of resistance and a variation of electric charge in the sheet of paper.

12. The apparatus of claim 8, wherein both the first and the second rollers are formed of a same metal material.

13. The apparatus of claim 1, wherein one of the first and second surfaces of the sheet of paper is an image forming surface, and the other of the first and second surfaces of the sheet of paper is a non-image forming surface.

14. A paper feeding apparatus comprising:
a first roller which rotates in a paper feeding direction;
a second roller; and
a multi-sheet feed preventer having a critical torque value and rotatably disposed on the second shaft to selectively rotate the second roller in a direction opposite the paper feeding direction when a frictional force between the sheet and the first roller is greater than the critical torque value,
wherein, when a sheet and an additional sheet are advanced between the first and second rollers, a first frictional force F1 between the sheet and the first roller, a second frictional force F2 between the sheet and the additional sheet, and a third frictional force F3 between the additional sheet of paper and the second roller have magnitudes in order of F1>F3>F2, respectively, and F3 is less than the critical torque value.

15. The apparatus of claim 14, further comprising a ground, wherein at least one of the first and the second rollers is metal, and the ground removes static electricity the at least one metal roller.

16. The apparatus of claim 14, further comprising a voltage source, wherein at least one of the first and the second rollers is metal, and the voltage source equalizes an electromagnetic characteristic of the paper through the at least one metal roller.

17. The apparatus of claim 16, wherein the electromagnetic characteristic is a deviation in one of a resistance and a charge uniformity.

18. The apparatus of claim 14, further comprising:
a ground; and
a voltage source,
wherein the first and the second rollers are metal, the ground removes static electricity from the one of the metal rollers, and the voltage source equalizes an electromagnetic characteristic of the paper through the other of the metal rollers.

19. The apparatus of claim 14, wherein at least one of the first and the second rollers is metal and the metal is one of Cu, Al, Au, Ag, Pt, Fe, Pd, Ni, stainless steel, and an alloy containing one of Cu, Al, Au, Ag, Pt, Fe, Pd, Ni, stainless steel as a chief ingredient.

20. The apparatus of claim 14, wherein at least one of the first and the second rollers is rubber material.

21. The apparatus of claim 14, wherein the rubber material is one of an NR series, an NBR series, an EPDM series, a urethane series, and a silicon series.

22. The apparatus of claim 14, wherein the multi-sheet feed preventer is a torque limiter.

23. The apparatus of claim 14, wherein the first roller is formed of a metal material which is not thermally deformed during operation of the apparatus.

24. The apparatus of claim 23, wherein the metal material has a coefficient of friction which does not change during operation of the apparatus.

25. The apparatus of claim 14, wherein the first and second feed rollers are formed of same metal material.

26. The apparatus of claim 14, further comprising first and second voltage sources which respectively apply first and second voltages to the first and second rollers, wherein the first and the second rollers are metal.

27. A paper feeding method, comprising:
rotating a first roller disposed toward a first surface of a sheet of paper conveyed through a paper feeding path;
rotating a second roller disposed toward a second surface of the sheet of paper in the paper feeding direction;
selectively rotating the second roller in the direction opposite to the paper feeding direction to prevent a multi sheet feed; and
selectively transmitting a driving force to the first and the second rollers,
wherein the first roller is disposed on a first shaft having a first roller gear which receives the driving force and rotates the first roller,
wherein the second roller is disposed on a second shaft having a second roller gear which receives the driving force and rotates the second shaft in a direction opposite to the paper feeding direction, and
wherein at least one of the first and the second rollers is formed of metal material.
